(19) United States
(12) Patent Application Publication
(10) Pub. No.: US 2007/0264617 A1
(43) Pub. Date: Nov. 15, 2007

(54) Reconfigurable non-pilot aircrew training system

(76) Inventors: Mark Richardson, Almonte (CA); Paigc Cutland, Stittsville (CA)

Correspondence Address: SMART & BIGGAR;P.O. BOX 2999, STATION D, 900-55 METCALFE STREET, OTTAWA, ON, K1P5Y6, CA

(21) Appl. No.: 11/432,327

(22) Filed: May 12, 2006

(51) Int. Cl. G09B 9/08

(52) U.S. Cl. 434/30

(57) ABSTRACT

A reconfigurable non-pilot aircrew training system is provided. The system comprises an air-based system comprising a plurality of student workstations and at least one instructor workstation, wherein each workstations runs a simulation engine that controls models of different sensors/systems associated with a plurality of different aircraft in order to provide training simulations for different aircrew personnel classifications. Individual workstations can be grouped into “virtual crews” to train in a particular simulated exercise. State information blocks associated with each model allow for the configuration, monitoring and recording of simulations. A corresponding ground-based training system is also provided, which is adapted for debriefing of in-flight simulation data that was collected during training with the air-based system.

### FIELD OF THE INVENTION

The invention relates to systems and methods for training non-pilot aircrew.

### BACKGROUND OF THE INVENTION

There are a variety of operational aircraft used in roles such as attack, surveillance and reconnaissance that employ aircrew other than pilots to operate a variety of systems and sensors in the conduct of those aircraft roles. The sensors and systems used by these non-pilot aircrews (navigators, sensor operators, electronic warfare operators, observers, etc.) are continuously becoming more complex. Advanced training systems are required to effectively and efficiently prepare tomorrow's tactical aircrews.

The conventional approach to training such aircrews was to include a ground-based educational component followed by an air training component in a particular aircraft for which the particular tactical aircrew is being trained. The cost of performing such training in the actual aircraft is very high.

In an existing effort to deal with this complex training exercise, a system referred to as a “Tactical Mission Training system” (TMT) was developed, as described in a May 2002 publication entitled “Aerospace International”. The TMT provides for an air-based platform implemented in a training aircraft different from that for which the aircrew are being trained. There is also a ground training component that operates using the same system interfaces as used in the air component. This was implemented in a Bombardier CT-142 DASH-8, and the operating costs of such an aircraft are low compared to many existing pure-jet and older-generation turbo prop tactical mission trainers.

### SUMMARY OF THE INVENTION

According to one aspect of the present invention, there is provided a reconfigurable aircrew training system comprising an air-based system comprising: a plurality of student workstations and at least one instructor workstation; an aircraft interface for interfacing with an aircraft training platform; a network interconnecting the plurality of student workstations, the at least one instructor workstation and the aircraft interface; wherein each student workstation is reconfigurable to A) simulate specific aircraft systems and sensors selected from a set of available systems and sensors and B) simulate training needs of a specific aircrew personnel classification selected from a set of available aircrew personnel classifications.

In some embodiments, each student workstation comprises: a simulation engine; a plurality of models running under control of the simulation engine; a user interface.

In some embodiments, each student workstation further comprises an information sharing mechanism for sharing information with other workstations.

In some embodiments, the plurality of models comprise at least one sensor or system model selected from a group consisting of:

Navigation, Communications, Data-link, Mission Management Systems, Radar, Electro-Optic/Infra-red (EO/IR) Sensors, Electronic Warfare (EW) systems, aircraft self-protection systems, Acoustic Sensors, Magnetic Anomaly Detection (MAD), and Weapons systems.

In some embodiments, the aircraft interface comprises: at least one interface for receiving sensor information from the aircraft training platform.

In some embodiments, the aircraft interface provides at least one of: an interface for receiving power; an interface for controlling live aircraft systems including at least one of radar, radios and navigation systems; and an interface to a flight management system.

In some embodiments, for at least one sensor/system, an interface for connection to a live sensor/system implementation of the aircraft training platform, and a model that simulates the sensor/system.

In some embodiments, the system is adapted to provide a blend of live and synthetic systems and sensors through an overlay presentation of live and synthetic information.

In some embodiments, the system is adapted to control the blend of live and synthetic systems and sensors for each student workstation individually.

In some embodiments, the set of aircrew personnel classifications comprise at least two selected from a group consisting of: Navigator, Combat System Officer, Naval Flight Officer, Sensor Operator, Observer, Aircrewman, Sonarman, and Airborne Electronic Sensor Operator.

In some embodiments, for a given aircraft being simulated, the plurality of models comprise a respective set of models provided that simulate sensors/systems of the given aircraft being simulated.

In some embodiments, a subset of sensors/systems that are to be learned by a given aircrew personnel classification is defined.

In some embodiments, the subset of sensors/systems that are to be learned by a given aircrew personnel classification is defined in a graduated fashion from a reduced subset to a full subset that the given aircrew personnel classification is assigned to learn.

In some embodiments: each student workstation comprises a user interface through which to receive student identification information from a student using the student workstation; and the workstation is adapted to, upon receiving student identification information reconfigure itself for the aircrew classification associated with the received student identification information.

In some embodiments, a mission recorder that records at least one of operator inputs, aircraft and synthetic entity movements, tactical plot info, synthetic information, and data received from aircraft systems.

In some embodiments, the simulation engine of each student workstation is adapted to manage communication with the other student workstations and is adapted to send and receive information to the aircraft interface.

In some embodiments the system further comprises at least one instructor workstation, wherein the simulation engine of each workstation is adapted to manage communication with the other workstations and is adapted to send and receive information to the aircraft interface.

In some embodiments, the simulation engine of multiple workstations work together to perform load balancing so as to avoid running out of processing power on one workstation.

In some embodiments, each student workstation has a plurality of processors.

In some embodiments, one of the models is a radar model provided as a separate executable application on a separate one of the plurality of processors of each student workstation; one of the models is an EO/IR model provided as a separate executable application on another separate one of the plurality of processors of each student workstation, one of the models is an acoustics model provided as a separate executable application on yet another separate processor of the plurality of processors of each student workstation.

In some embodiments, radar information is provided to the student workstation using at least one of: an onboard radar system that provides live radar information to the system through the aircraft interface; an onboard radar system that provides live radar information in combination with superimposed synthetic targets and returns; and an entirely synthetic radar system.

In some embodiments, a plurality of radar modes are simulated, and wherein a subset of the plurality of radar modes to be trained is selectable on a per-student basis.

In some embodiments, the system is adapted to selectably implement the following scenarios: an individual workstation running a separate independent simulation with the possible exception of information coming from the aircraft interface in the event that those interfaces are active; and workstations grouped together into one or more groups of workstations each constituting a “virtual crew”, with different crewmembers being assigned a respective aircrew personnel classification within a given virtual crew, such that activity by a model on one of the group of workstations will effect the corresponding models on the other workstations of the group.

In some embodiments, different mission scenarios and targets can be assigned to different workstations that may be operating independently or joined as part of the same virtual crew.

In some embodiments, any number of individual workstations and virtual crews can be arbitrarily defined for simultaneous operation subject to a limitation of how many workstations there are.

In some embodiments, for each workstation, each model generates a SIB (state information block) that is an update of information from that model that is shared with other models in that work station and with models on other workstations.

In some embodiments, each workstation comprises an information sharing mechanism that makes the SIBs generated by each model of that workstation available to other models on the workstation, and makes the SIBs available to models on other workstations, and that receives SIBs from models on other workstations and makes these available to models on the workstation.

In some embodiments, every time an attribute of a SIB changes, the information sharing mechanism updates the entire system.

In some embodiments, all of the state information blocks are periodically written to memory such that there is a complete state of the system that is periodically defined by the SIBs collectively.

In some embodiments, the system further comprises a ground-based system.

In some embodiments, a common software application is used in the air-based system and in the ground-based training system.

In some embodiments, the air-based system is further adapted to produce a simulation output that can be input to the ground-based system so that the simulations that were performed in an air environment can be examined in the ground-based system for debriefing purposes.

In some embodiments, after downloading the simulation output to the ground-based system, the ground-based system provides mission replay controls comprising fast forward, rewind and jump to bookmarks, and provides replay options comprising at least one of tactical plot information, operator selections, audio, synthetic entity and weather movement.

In some embodiments, the plurality of student workstations and the at least one instructor workstation are each reconfigurable to function as either a student workstation or an instructor workstation.

In some embodiments, the at least one instructor workstation has an interface for controlling student scenarios, and level of difficulty.

In some embodiments, the at least one instructor workstation has an interface for inserting faults and/or for selectively failing equipment for each student workstation independently.

In some embodiments, each instructor workstation comprises an IOS (instructor operating system) that is a separate application that allows an instructor to communicate with students through the simulation engines.

In some embodiments, the IOS comprises interfaces and functionality for at least one of: building virtual crew; setting up scenarios and exercises; modifying an exercise in real time; adding new targets, adding weather or adding weapons fire; selectively degrading or failing equipment; controlling live vs. synthetic blend for at least one sensor/system; and inserting “bookmarks” for event finding in debrief.

According to another aspect of the present invention, there is provided one or more computer readable media having computer executable instructions for implementing an aircrew training simulator when executed on a computer, the computer executable instructions comprising: a simulation engine; a plurality of models running under control of the simulation engine; a user interface; the aircrew training simulator being reconfigurable to A) simulate specific aircraft systems and sensors selected from a set of available systems and sensor and B) simulate training needs of a specific aircrew personnel classification selected from a set of available aircrew personnel classifications.

In some embodiments, the computer executable instructions further comprise: an information sharing mechanism for sharing information with other workstations.

In some embodiments, the instructions further comprise: instructions for implementing a plurality of state information blocks as a mechanism for sharing information with other workstations; and instructions for implementing at least one SIB interface, a SIB interface collecting information from an external device and composing it into a SIB for use by the simulator.

In some embodiments, the instructions further comprise instructions that when executed provide an instructor operating system.

In some embodiments, the instructions further comprise instructions that when executed provide ground simulator functionality.

In another embodiment of the invention, a student workstation is provided as summarized above. A student workstation comprises a workstation in combination with specific hardware and/or software that implements the student-specific functionality.

In another embodiment of the invention, an instructor workstation is provided. An instructor workstation comprises a workstation in combination with specific hardware and/or software that implements the instructor-specific functionality.

In another embodiment of the invention, one or more computer readable media are provided that implement computer readable instructions for execution on a student workstation and/or an instructor workstation as summarized above. In some embodiments, a different application is provided for the student workstation as opposed to the instructor workstation. In other embodiments, a single application is provided, and the student or instructor functionality can be selectively activated.

### BRIEF DESCRIPTION OF THE DRAWINGS

Embodiments of the invention will now be described with reference to the attached drawings in which:

FIG. 1 is a schematic diagram of an example of a reconfigurable non-pilot aircrew training system provided by an embodiment of the invention;

FIG. 2 is a block diagram of an example implementation of the reconfigurable non-pilot aircrew training system;

FIG. 3 is a pictorial and block diagram representation of an example implementation of a student work station and/or instructor workstation;

FIG. 4 is a block diagram of the simulator that is implemented on a single workstation;

FIG. 5 is a block diagram of a reconfigurable non-pilot aircrew training system with a very specific set of models being implemented; and

FIGS. 6 through 10 are block diagrams detailing an example implementation of the simulation engine.

### DETAILED DESCRIPTION OF THE PREFERRED EMBODIMENTS

A problem with existing training systems such as the Tactical Mission Training system described in the background is that such systems are designed on a one-off basis, with a new design being implemented for each aircraft being simulated. Furthermore, the existing systems do not have the flexibility to easily add sensors or to train new aircrew classifications. Rather, these are defined statically, again on a one-off basis. Furthermore, the systems have traditionally been designed in an integrated fashion with the training aircraft, for example the Dash-8 aircraft for the TMT, and that aircraft then became a dedicated training aircraft.

A new re-configurable non-pilot aircrew training system (RNATS) is provided. Depending upon implementation specifics, various advantages may be realized compared to the existing systems:

the system can be installed in an arbitrarily selected training aircraft;

the characteristics of the various sensors can be fine tuned or defined for a given aircraft being trained;

sensors can be added or updated or removed;

the system can be easily installed and removed from a training aircraft such that the training aircraft can be used for other purposes;

aircrew classifications can be added or removed, each aircrew classification being given access to a defined subset of functions that they are to learn; the following is an example of a non-exhaustive list of possible aircrew classifications: Navigator, Combat System Officer, Naval Flight Officer, Sensor Operator, Observer, Aircrewman, Sonarman, Airborne Electronic Sensor Operator. The particular set of aircrew simulated is implementation specific; aircrew classifications may have different names in different jurisdictions;

the subset of functions that are assigned to be learned by a given aircrew classification can be dynamically defined; the operational training on a specific aircraft type may require that the graduate of initial training has obtained an understanding of the theory of operation and airborne application of a particular subset of the following types of systems and sensors as applicable to their specific aircrew classification: Navigation, Communications, Data-link, Mission Management Systems, Radar whose modes include weather, ground mapping, targeting, Synthetic Aperture Radar (SAR), Inverse Synthetic Aperture Radar (ISAR), Ground Moving Target Indication (GMTI), Air-to-Air search and track, Electro-Optic/Infra-red (EO/IR) sensors, Electronic Warfare systems including Electronic Attack, Electronic Support Measures (ESM), and aircraft self-protection systems, Acoustic sensors including sonobuoy processing and dipping sonar (SPS), Magnetic Anomaly Detection (MAD), Weapons systems. Again, these are implementation specific; different sensors and systems may be provided;

a generic interface to a graphical user interface is provided such that the graphical user interface can be designed to have a desired appearance for a given aircraft being simulated and/or for a particular aircrew classification;

the same system can be used to simulate different aircraft and different aircrew classifications.

Some implementations also feature a ground-based system that is similar to the air-based system with differences noted below.

Flying training is very expensive and the new system can be used for an initial tailored training and selection process to ensure only the most suitable candidates advance to operational training. A reduction in the failure rate at the operational training level will reduce training costs. The ability to “down-load” training from the operational training units to the initial training system, where flying training can be done on a much less expensive airborne platform, will reduce training costs. The ability to simulate in an airborne platform a complete range of sensors and systems means that these systems do not need to be purchased and installed on the training aircraft. This may dramatically lower the aircraft acquisition, modification and life cycle maintenance costs. The ability of the system to reconfigure means that a single training system may be used to train multiple aircrew types which will eliminate the need to procure or maintain multiple specific aircrew training systems. The simplified life-cycle management of a single common training tool instead of many will reduce training costs.

For a given aircraft type, there may be an operational requirement for an annual supply of suitable aircrew of a set of defined types to enter operational training to man the aircraft type. The primary methodology to provide a pool of qualified aircrew to enter operational training is to recruit civilian aircrew into the armed service who first undertake initial training. The goal of initial training, also referred to as under-graduate aircrew training, is to provide a training program that will only graduate suitable candidates who can then succeed in the more complicated follow-on training on the operational aircraft. The successful completion of initial training normally results in the awarding of wings or a qualification badge specific to that aircrew type.

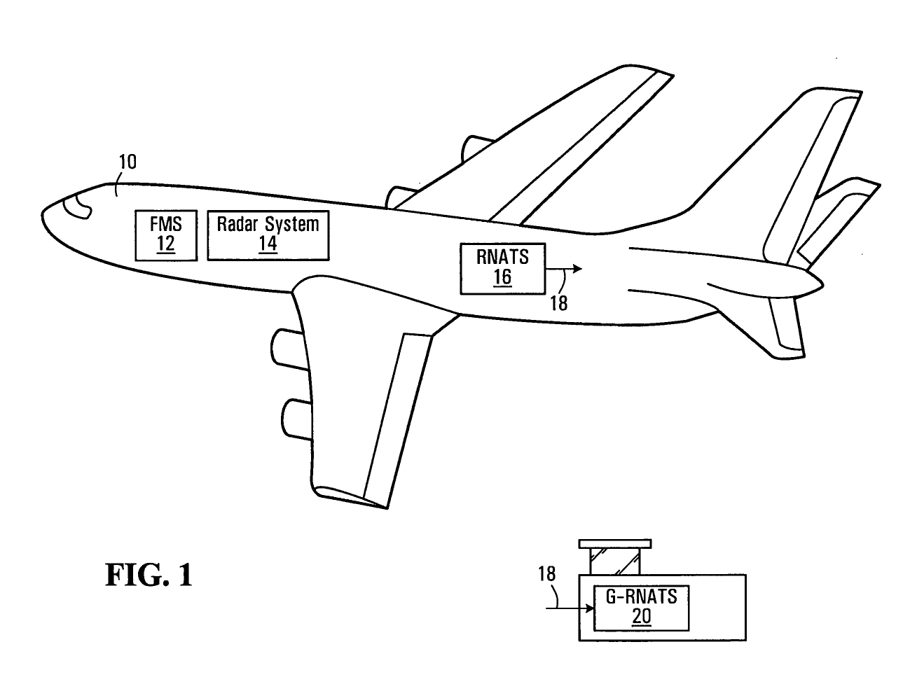

Referring now to FIG. 1, shown is a schematic diagram of an example deployment of the RNATS. An aircraft training platform is generally indicated at 10, and this is assumed to include a flight management system (FMS) 12. In some instances, there may also be a radar system 14 on the training aircraft 10. Also shown is the RNATS 16. As discussed above, in some implementations the RNATS 16 is a portable system that can be installed and removed from the aircraft training platform 10. However, this is not to say that in a given application the system could not be permanently installed.

Some instances of the system also include a ground-based component referred to in the illustrated example as a G-RNATS 20. In some embodiments, simulation output 18 produced by the RNATS 16 can be input to the ground-based component 20 so that the simulations that were performed in the air environment can be examined in the ground environment for debriefing purposes.

The aircraft training platform 10 may be a low-cost aircraft training platform such as a turbo-prop (Bombardier Dash-8, Beechcraft King-Air), or business jet (Lear 60, Hawker Horizon) aircraft to name a few examples.

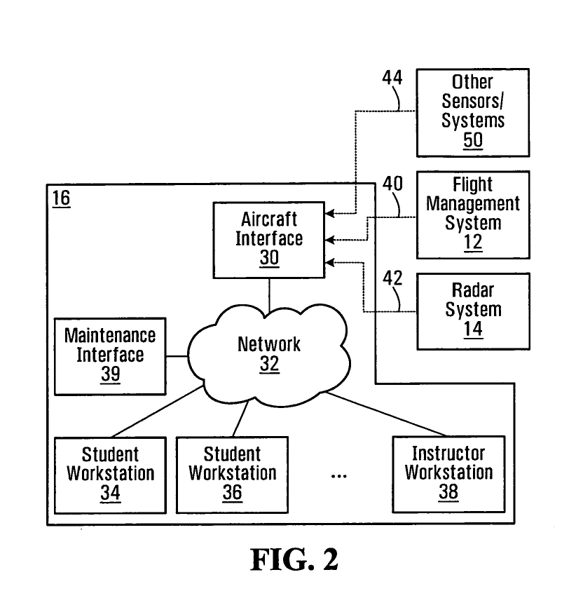

Referring now to FIG. 2, shown is a block diagram of an example implementation of the RNATS 16. The RNATS 16 is shown equipped with an interface 40 for connection to a flight management system 12 of an aircraft training platform, and an interface 42 for connection to a radar system 14 of an aircraft training platform. In some embodiments, the interface to the flight management system 12 when present is implemented using the standardized ARINC 429 interface. Also shown is an interface 44 for connection to other sensors/systems of an aircraft training platform, generally indicated at 50. These might for example include one or more interfaces to receive power, and/or interfaces to control live aircraft systems such as the radar, radios or navigation systems. The inclusion of one or more of the interfaces 40, 42, 44 is an implementation specific detail. In some implementations, there are no interfaces to the training aircraft with the exception of one for receiving power, and all sensor, flight management system and radar information is simulated by the RNATS 16. Other implementations include one or more of the interfaces 40, 42, 44 as shown. Some embodiments enable both options for one or more of the interface types; for example the RNATS 16 may include a radar system model and an interface for optional connection to a physical radar system; the RNATS 16 may include a flight management system model and an interface for optional connection to a physical flight management system; and/or the RNATS 16 may include multiple sensor models and interfaces 44 for optional connection to physical sensors 50.

The RNATS 16 has an aircraft interface 30 that is available to be interconnected to any interfaces 40, 42, 44 with the training aircraft. Also shown is a plurality of student workstations 34, 36 and an instructor workstation 38 connected to the aircraft interface 30 through a network 32. More generally, there can be any number of student workstations and instructor workstations. The instructor workstation 38 can physically be the same as a student workstation with different privileges implemented; alternatively, a different workstation can be provided. For example, the instructor workstation might be a scaled down unit such as a laptop computer. The network 32 is any network allowing for the interconnection of the various workstations and the aircraft interface 30. For example, the network might be MIL 1553B, Ethernet to name a few specific examples.

Also shown is a maintenance interface 39. This might be implemented in the instructor workstation 38, or on a separate device. The maintenance interface 39 provides an interface through which to define or simply load aircrew classifications, and to manage user access credentials. For example, in some embodiments, students are required to log on to their workstations with student identification information such as a user ID and a password; after logging on, the student workstation is configured for their particular aircrew classification. The user ID, password and aircrew classification information can be entered via the maintenance interface 39.

In some implementations, the G-RNATS 20 of FIG. 1 is implemented substantially the same as the RNATS 16 of FIG. 2, with the exception that there would be no interfaces to the training aircraft, and as such everything must be simulated.

Brief/Debrief

In some embodiments, the ground based system allows for the creation and importation into RNATS of student mission plans. This might for example include fly-to-points (FTP), areas, communications, and navigation data.

RNATS provides for mission recording of one or more of operator inputs, aircraft and synthetic entity movements, tactical plot info, all synthetic info, all data received from aircraft systems. When downloaded to G-RNATS, mission replay control allows for an instructor to fast forward, rewind and jump to bookmarks, and to replay one or more of tactical plot information, operator selections, audio, synthetic entity and weather movement. During replay, synthetic sensor video can be regenerated. The recorded data is run through the synthetic sensor just like it was running in real time, and the sensor generates the same video seen during the recording. This precludes the need to record hours of video which would be memory intensive.

The G-RNATS also allows for the replay of aircraft mission data and then re-commence or go “live” in a ground based training scenario from a selected point.

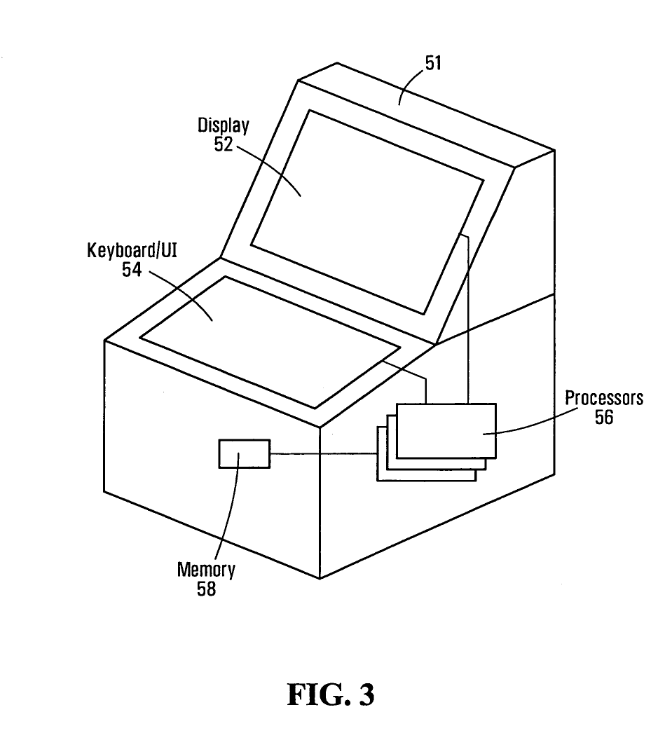

Referring now to FIG. 3, shown is both a pictorial and block diagram representation of an example implementation for one of the student workstations 34 and/or instructor workstations 38 of FIG. 2. In the illustrated example, the workstation generally indicated at 51 has a console appearance with a display 52 and a keyboard/user interface 54. In some embodiments, each workstation is a multi-processor workstation; in the illustrated example, there are three processors 56 in each workstation, but more generally any number of processors can be implemented. Also shown is a memory 58.

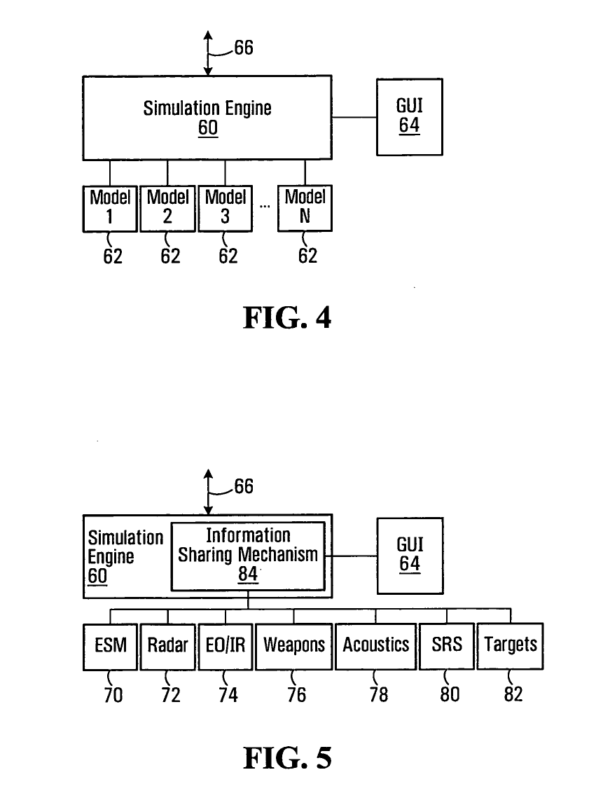

Referring now to FIG. 4, shown is a block diagram of an example implementation of the functionality that is implemented on the student workstations 34 and/or instructor workstations 38 of FIG. 2. Shown is a simulation engine 60 functionally interconnected to a plurality of models 62 and a graphical user interface (GUI) 64. In some embodiments, the simulation engine 60 is first executable; the GUI 64 is a second executable, and each of the models 62 operate as part of the simulation engine executable 60. In other implementations, one or more of the models 62 can be assigned their own executable. For multi-processor implementations, particularly processor intensive models can be executed as their own executable on a separate processor.

The simulation engine 60 is responsible for modelling of time for all elements in the scenario such as entity motion, weather motion, diurnal effects, and modelling of all scenario interactions between entities. The simulation engine controls time for everything, as well as the execution of the simulated sensors, systems, entities, environment etc.

Each of the models 62 implements a respective aspect of the simulation. Specific examples of models that may be included include ESM, radar, weapons, acoustics, SPS, EO/IR, and targets. Models can be added or removed as desired to create a particular training platform. Further details of sensors and systems that might be modeled are provided below.

In some embodiments, one or more models provides a simulated world environment to provide any simulated systems or sensors with necessary stimuli including terrain modelling, atmospheric modelling, and target entity modelling. This can be referred to as synthetic environment modelling, and may include modelling of terrain for visual, infra-red and radar sensors, modelling of weather, modelling of entities which may be mobile (ships, aircraft, tanks) or static (airfield, factory), modelling of RF propagation effects for appropriate systems.

The simulation engine 60 is also responsible for managing communication 66 with the other student workstations where appropriate and/or the instructor workstation where appropriate, and for sending and receiving information to the aircraft interface.

In some implementations, the simulation engines 60 of multiple workstations can work together to perform load balancing so as to avoid running out of processing power on one device. In some implementations, all models are physically present on every workstation. Since the simulation engine is responsible for the execution of every model, the simulation engine monitors the processor load on each station and determines when one processor is over tasked. When a given processor load is too high, another copy of the model currently being run on the overloaded processor is stacked on another machine, and the local copy is shut down. For the ground-based implementation, an extra workstation can be provided that simulates the flight information.

FIG. 5 is a block diagram similar to FIG. 4, but in which a very specific set of models is shown as being implemented. These include an ESM model 70, a radar model 72, an EO/IR model 74, a weapons model 76, an acoustics model 78, an SRS model 80, and a targets model 82. The functionality implemented by any of-these models is implementation specific. The following is a description of an example of functionality that might be modelled.

The Electronic Support Measures (ESM) model simulates the early warning and threat detection system of an actual aircraft. This system is used to detect various types of radars from entities in the environment, from navigation radars (low threat) to missile homing radars (high threat). The ESM model monitors the simulated radars in the simulation, as well as the own aircraft position, environmental conditions, and terrain occultation to determine when the own aircraft has been illuminated by the simulated radars.

The Radar model simulates various types of airborne radars, as well as the various modes utilized by each. These may include Real Beam Ground Map (RGBM), Doppler Beam Sharpening (DBS), Weather modes, Synthetic Aperture Radar (SAR), Inverse Synthetic Aperture Radar (ISAR), Air-to-Air, Air-to-Ground, etc. The Radar model utilizes the own aircraft position, simulated environmental conditions, entities, and operator selected modes to render a highly realistic radar video image.

The Electro Optic/Infra Red (EO/IR) model utilizes the own aircraft position, entity positions, environmental conditions, as well as a detailed terrain database to render high fidelity EO and IR images.

The Weapons model simulates the various types of weapons used in the simulation. The model will utilize all of the positional information for own aircraft and entities in the simulation, as well as predetermined performance characteristics to simulate the trajectory and effect of the simulated weapons.

The Acoustic model uses simulated sonobuoys, an ocean model (ocean characteristics), as well the surface and subsurface entities within the simulation to produce an underwater acoustic environment.

The Sonobuoy Receiver System model (SRS) simulates the system that is responsible for tuning and controlling the simulated sonobuoys in the environment.

The Targets model controls the various targets (entities) in the simulation. This includes kinematics and responses to stimulus (like weapons firings and illumination by radar).

FIG. 5 also shows an information sharing mechanism 84 as part of the simulation engine 60. This is a component that is responsible for receiving information from other system elements, such as other student workstations and an instructor workstation and the aircraft interface 30, updating local models accordingly, and sending information generated by the local models to other system elements.

In a particular embodiment, the radar model 72 is a separate executable application on a separate processor and/or the EO/IR model 74 is a separate executable application on a separate processor, and/or the acoustics model 78 is a separate executable application on a separate processor.

Radar

In some embodiments, the system supports various alternatives for implementing radar. In a first example, an onboard radar system is provided that provides live radar information to the RNATS through the aircraft interface. In some embodiments, this live radar system is a less-expensive radar system than would be implemented in the aircraft being simulated. If there is no simulation involved, then only the live radar video is displayed and no simulation is done for the radar picture.

In a second option, live radar is provided with the additional option of superimposing synthetic targets and returns. This might be achieved by video overlay for example.

In a third option, the entire radar experience is simulated.

Some modern radars have many different modes, for example up to 13 modes. In some embodiments, the set of radar modes that are available are selected on a per-student basis.

More generally, in some embodiments for one or more simulation aspect, radar being a specific example, the system is adapted to allow the blending of live and synthetic elements at run time to create a seamless training environment combining the two.

Some of the models that are included may be aircraft specific in which case when configuring the workstation to train for a particular aircraft, the aircraft specific model is installed or activated. Other models may be appropriate for use across multiple aircraft types. Thus, to configure a workstation to simulate a given aircraft, the various models are configured to represent that aircraft.

A simulated aircrew classification consists of one or more definitions that define the types of training that that aircrew classification needs to undergo. In a particular example, a given aircrew classification may simply consist of a subset of the available models that are to be activated for that simulated aircrew classification. Equivalently, they might consist of a set of sensors and systems for the classification.

The GUI 64 presents a display and available user inputs. The GUI is reconfigurable to present an appropriate display for the different simulated aircrew classifications. Furthermore, in some implementations, the set of capabilities made available to a person being trained through the GUI 64 is structured to change in a graduated fashion such that initially a smaller set of capabilities is available and as training progresses, a more complete set of capabilities is made available.

In some embodiments, the student workstation self reconfigures upon user login. Each user is assigned aircrew classification, a user ID and a password. Once the user logs on with that user ID and that password, the appropriate set up for that aircrew classification is activated.

Some of the models are executed periodically under control of the simulation engine 60. The frequency with which the different models are executed can be the same or different for different models. Furthermore, as indicated previously some of the models may have their own executables in which case they do not necessarily need to be scheduled by the simulation engine 60.

The following are examples of scenarios that can be implemented using the system:

1) Each workstation is running a separate independent simulation with the possible exception of information coming from the aircraft interface in the event that those interfaces are active;

2) Multiple workstations are grouped together as a “virtual aircraft” to train a “virtual crew”. In this case, the different crewmembers can be assigned their various aircrew classification. Activity by a model on one of the group of workstations will effect the corresponding models on the other workstations. They will also share information from the aircraft interface, and if that is not implemented they will share simulated physical location information. In some implementations, where a virtual crew arrangement has been set up, different targets can be assigned to different workstations. There can be multiple virtual crews training simultaneously.

Instructor Workstation

The instructor workstation is equipped with an IOS (instructor operating system) which is a separate application that allows the instructor to communicate with the students through the simulation engines. Using the IOS, an instructor can build the virtual aircraft/crew as discussed above. The instructor can set up scenarios and exercises. A scenario consists of a set of starting conditions such as temperature, time, targets, etc. An instructor selects a scenario to run for the student. This sets up the “world” at the beginning. Once he hits “start”, it is now called an Exercise (thus, the run-time instantiation of a Scenario). He selects a precanned Scenario, then executes it (thus it is an Exercise).

In some embodiments, the instructor operating system allows the instructor to modify the exercise in real time. For example, the instructor might be able to add new targets; add weather or add weapons fire. They may be also able to adjust models to simulate degradation and/or failure of equipment. For example, a navigation system may be set up to fail under control of the instructor.

The following is a further set of features that might be implemented in the instructor workstation:

A. Features to provide situational awareness of one or more of:

Actual versus student view—more specifically, what the student believes are the positions of the various entities, vs. where they actually are. This is similar to the own aircraft position; where the student THINKS he is, vs where he ACTUALLY is;

Student repeater—this provides a replication of the students display on the instructor's monitor;

Live versus synthetic targets;

Multi-student view—this provides the ability for the instructor to look at the repeated displays of more than one student at a time;

Communications view—this shows what radios and frequencies the student has selected for radio communications; and

System control view—this displays what the various selections are for the control of the various portions of the simulation.

B. Features that provide training control of one or more of:

synthetic entities behaviour;

weather;

system availability and degradation; and

live versus synthetic blend.

C. Features that provide the ability to insert “bookmarks” for event finding in debrief.

D. Features that allow for the automatic performance measurement of selected parameters. This could for example include reaction time between when a warning display is presented to a student and when he acknowledges it, or how far the student allows the aircraft to get off course before correction.

Referring to FIG. 5 again, as introduced above, each workstation including both student and instructor workstations has an information sharing mechanism 84. Generally speaking, the information sharing mechanism 84 is used to share information between student workstations, the aircraft interface, and instructor workstations via the network. In a particular implementation, the information sharing mechanism 84 collects state information blocks (SIBs) from each of the models being run on a workstation. A state information block in respect of a given model contains an update of any information from that model. These state information blocks are then sent over the network for receipt by other devices in the system. In some embodiments, every device in the system has such an information sharing mechanism, including the aircraft interface and instructor workstation. In some cases, each SIB is transported through the network to every device, and each device can process the SIB or not depending upon whether that device is interested in the contents of the SIB. The information sharing mechanism 84 also receives system information blocks from the network and makes these available to the models that need them. Various scenarios that define whether or not one device is interested in the SIB of another will be defined below.

Every time an attribute of a SIB changes, the information sharing mechanism 84 updates the entire system. In some embodiments, the state information blocks are periodically written to memory such that there is a complete state of the system that is periodically defined by the SIBs collectively. Each workstation joins a “channel”, which contains all of the SIBs that are needed for that workstation. SIBs are multicast to all workstations. The information sharing mechanism determines if the local workstation is a member of the channel, and passes the relevant SIBs on when required.

As indicated previously the system can be adapted to simulate any aircraft. The following is a non-exhaustive list of aircraft that might be simulated using the system through appropriate reconfiguration:

aircraft that fulfil a number of missions in the category of Airborne Attack or Bomber. These are usually large multi-engine aircraft such as the B-1 Spirit, B-52 Stratofortress and F-18E Super Hornet;

aircraft that fulfil a number of missions in the category of Airborne Intelligence, Surveillance and Reconnaissance (ISR). These are usually large multi-engine aircraft such as the J-8 Joint Surveillance Targeting and Reconnaissance System (JSTARS), E-3 Airborne Warning and Control System (AWACS), RC-135 Rivet Joint, EP-3 Aries, Sentinel Mk.1, EA-6B Prowler and EA-18G Growler; and

aircraft that fulfil a number of missions in the category of Maritime Patrol, Surveillance and Control that are typically multi-engine aircraft or helicopters such as the P-3 Orion and derivatives, P-8 Poseidon, Nimrod MR.2 or MRA.4, SH-60 Seahawk and derivatives, Merlin Mk.1 and Dassault Atlantique.

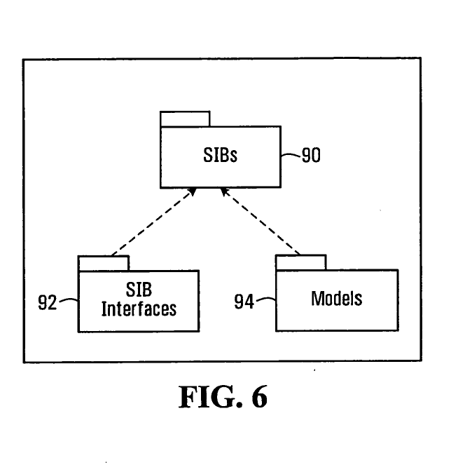

A particular example implementation of the simulation engine will now be described with reference to FIGS. 6 to 10. In some embodiments, the simulation engine operates with three abstractions referred to as State Information Blocks (SIBs), SIB Models, and SIB Interfaces.

Referring to FIG. 6, the components controlling the simulation engine can be grouped into these types: SIBs 90, SIB interfaces 92 and Models 94.

State Information Blocks

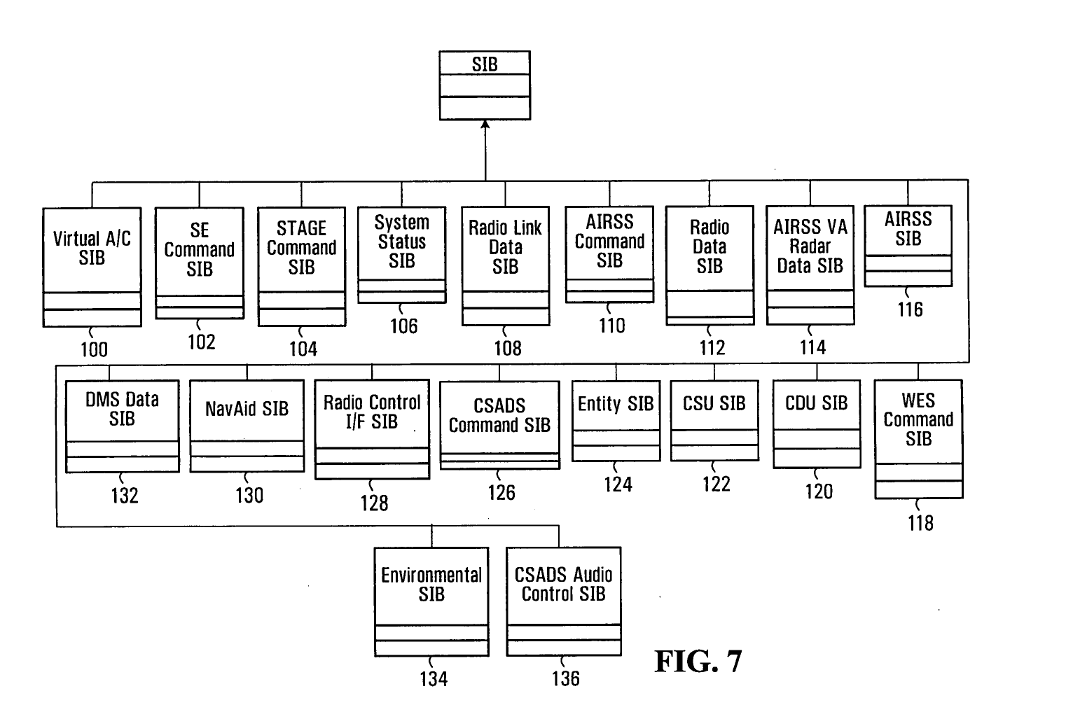

A SIB is a package of data that represents a block of state information. Collectively, the SIBs comprise all of the data required by the system. The SIB is the basic unit of information exchange within the distributed network. In some embodiments, each SIB registers with the simulation engine, and after that the simulation engine is responsible for distribution. An example set of SIBs is depicted in FIG. 7 and includes a respective SIB for each of: Virtual A/C SIB 100, SE Command 102, Stage Command 104, System Status SIB 106, Radio Link Data SIB 108, AIRSS Command SIB 110, Radio Data SIB 112, AIRSS VA Radar Data SIB 114, AIRSS SIB 116, WES Command SIB 118, CDU SIB 120, CSU SIB 122, Entity SIB 124, CSADS Command 126, Radio Control I/F SIB 128, NovAid SIB 130, DMS Data SIB 132, Environmental SIB 134 and CSADS Audio Control SIB 136.

Models

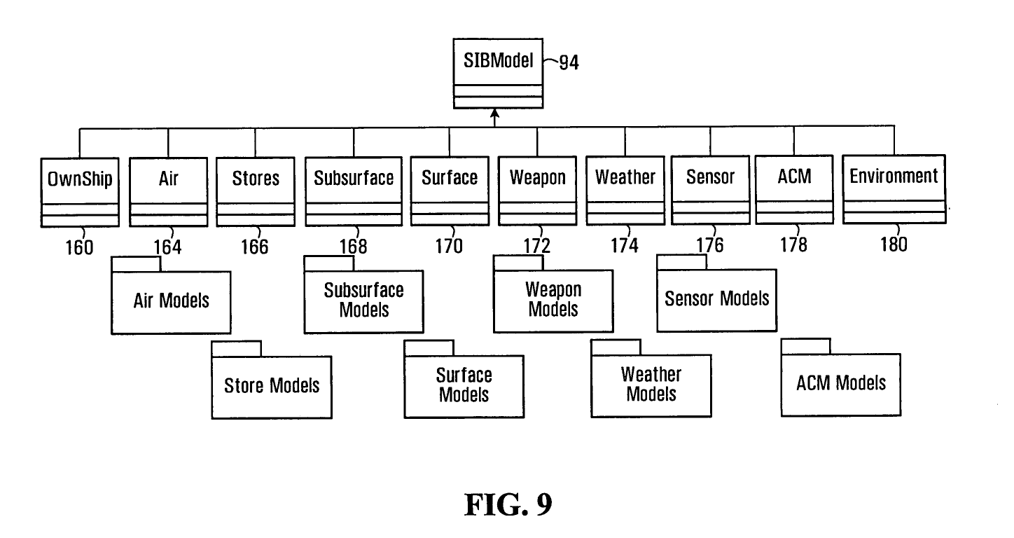

As introduced previously, models are the things that actually simulate something, like a GPS, an EO/IR, or a thunderstorm. Models manipulate SIBs based upon a predefined algorithm on a periodic basis, generally based on data generated during the previous modeling cycle. Each model registers with the simulation engine, and after registration, the simulation engine is responsible for execution control. The simulation engine manages runtime execution through the current state of associated channel (start, stop, pause/resume, etc.). A channel is a logical “pipe” through which all of the relevant SIBs for a given simulation are distributed. In some embodiments, the models operate independent of external system sources. An example set of models is depicted in FIG. 9 and includes OwnShip 160, Air 164, Stores 166, Subsurface 168, Surface 170, Weapon 172, Weather 174, Sensor 176, ACM 178 and Environment 180.

SIB Interfaces

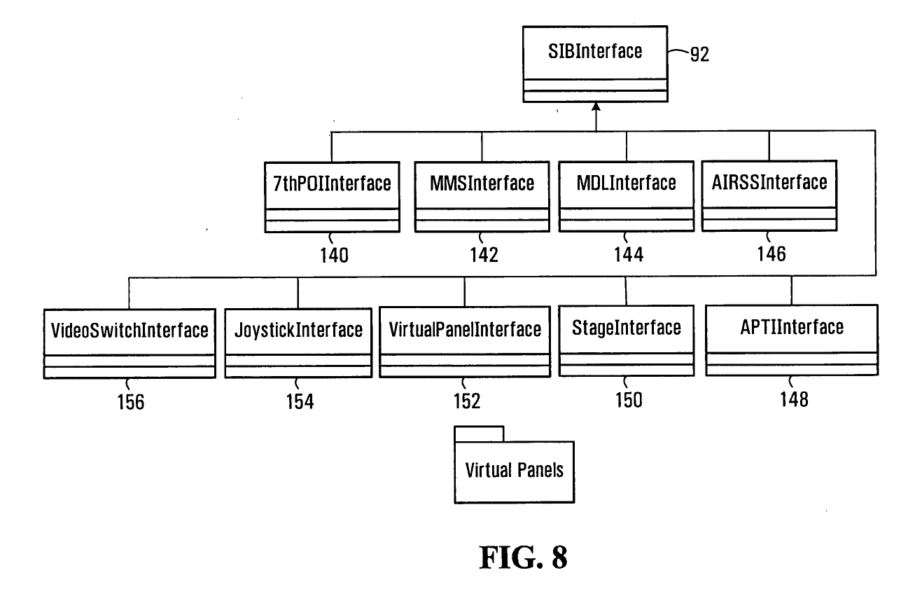

A SIB interface allows for connection to external devices. Examples of external devices that may be hooked up include an external radar simulator, an external acoustic subsystem, an external simulation network, a joystick, etc. An external device modifies or consumes SIB data independent of artificial time. SIB interfaces are software modules that run as part of the simulation and monitor an external interface that an external device updates. When the SIB interface notices a change, it picks up the changed data, puts it in a SIB, and distributes it. SIB interfaces provide a way to populate SIBs from external devices. The simulation engine manages control aspects of the software that monitors the data from the external source (Start, Stop, Pause, Resume) after registration. An example set of interfaces is depicted in FIG. 8 and includes the following interfaces: 7thPOIInterface 140, MMSInterface 142, MDLInterface 144, AIRSSInterface 146, APTInterface 148, StageInterface 150, VirtualPanelInterface 152, JoystickInterface 154 and VideoSwitchInterface 156.

The simulation engine resides on every machine in the RNATS. Client modules register SIBs, Models, and Interfaces with the local simulation engine. The simulation engine is then responsible for managing:

distributing of SIBs to all interested clients;

timed execution of registered Models;

management of registered SIB interfaces.

Management may include handling of run time states, record and playback, segregation of virtual aircraft, exercises, etc.

The following is an example set of functions through which clients can access simulator manager control:

RegisterStation—Registers the workstation with the simulation engine as a simulation participant;

Member Data—Allows access to the simulation engine data specifically attached to the workstation;

Channels—this exposes the channels (Exercises) currently available to join;

Open—opens a channel;

Request and Join—requests and joins a channel;

Start, Pause, Resume, Stop—these are callbacks to allow control of the workstation simulation models;

Register SIB—this registers any SIBs for which the workstation models are responsible;

Register Model—this registers the models that will be run and controlled by the simulation engine on the workstation;

Register Interface—this registers the interfaces that will be run and controlled by simulation engine on the workstation.

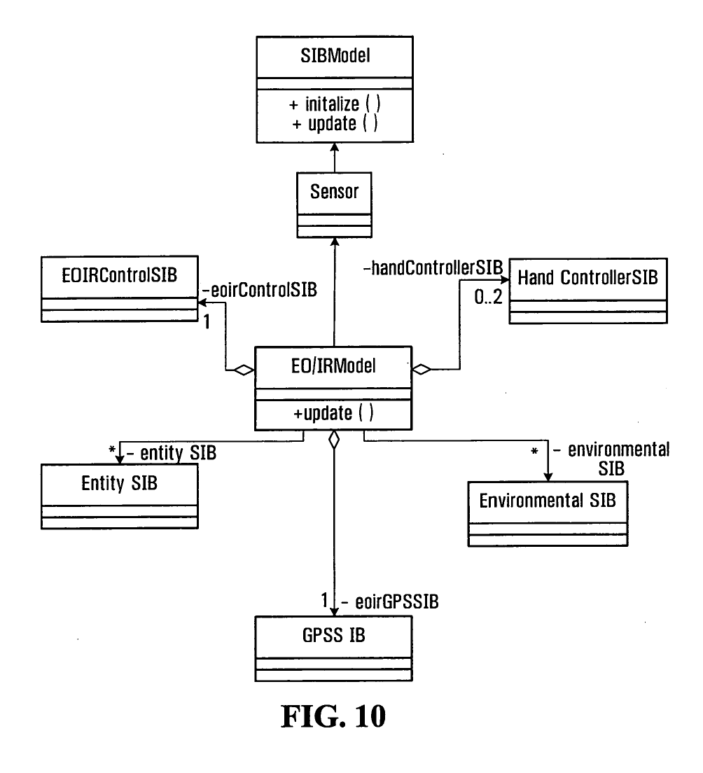

Referring now to FIG. 10, shown is an example of object structures and SIB flow for a single model, namely the EO/IR model. A similar diagram could be generated for each model.

SIBModel—The base class from which all models that have SIBs are derived.

Sensor—The base class from which all models that are sensors are derived.

EO/IR Model—The actual Electro Optic/Infra Red (EO/IR) model which utilizes the following SIBs to do it's simulation:

1. EOIRControlSIB
2. EntitySIB
3. GPSSIB
4. EnvironmentalSIB
5. HandControllerSIB

EOIRControlSIB—This is a SIB that contains control information for the simulated EO/IR.

EntitySIB—This is a SIB that contains the information on all of the entities in the simulation.

GPSSIB—This is a SIB that contains the GPS information (own aircraft true position).

EnvironmentalSIB—this is a SIB that contains all of the information pertaining to the environment, including clouds, rain, fog, snow, winds, etc. This information may effect the look and feel of the rendered image.

HandControllerSIB—This SIB contains the current EO/IR Hand Controller inputs used to control the EO/IR in Offline Mode.

Numerous modifications and variations of the present invention are possible in light of the above teachings. It is therefore to be understood that within the scope of the appended claims, the invention may be practiced otherwise than as specifically described herein.

We claim:

1. A reconfigurable aircrew training system comprising an air-based system comprising:
a plurality of student workstations and at least one instructor workstation;
an aircraft interface for interfacing with an aircraft training platform;
a network interconnecting the plurality of student workstations, the at least one instructor workstation and the aircraft interface;
wherein each student workstation is reconfigurable to A) simulate specific aircraft systems and sensors selected from a set of available systems and sensors and B) simulate training needs of a specific aircrew personnel classification selected from a set of available aircrew personnel classifications.

2. The system of claim 1 wherein each student workstation comprises:
a simulation engine;
a plurality of models running under control of the simulation engine;
a user interface.

3. The system of claim 2 wherein the plurality of models comprise at least one sensor or system model selected from a group consisting of:
Navigation, Communications, Data-link, Mission Management Systems, Radar, Electro-Optic/Infra-red (EO/IR) Sensors, Electronic Warfare (EW) systems, aircraft self-protection systems, Acoustic Sensors, Magnetic Anomaly Detection (MAD), and Weapons systems.

4. The system of claim 1 wherein the aircraft interface provides at least one of:
an interface for receiving power;
an interface for controlling live aircraft systems including at least one of radar, radios and navigation systems; and
an interface to a flight management system.

5. The system of claim 1 adapted to provide a blend of live and synthetic systems and sensors through an overlay presentation of live and synthetic information.

6. The system of claim 5 wherein the system is adapted to control the blend of live and synthetic systems and sensors for each student workstation individually.

7. The method of claim 1 wherein the set of aircrew personnel classifications comprise at least two selected from a group consisting of:
Navigator, Combat System Officer, Naval Flight Officer, Sensor Operator, Observer, Aircrewman, Sonarman, and Airborne Electronic Sensor Operator.

8. The system of claim 1 wherein a subset of sensors/systems that are to be learned by a given aircrew personnel classification is defined in a graduated fashion from a reduced subset to a full subset that the given aircrew personnel classification is assigned to learn.

9. The system of claim 1 wherein:
each student workstation comprises a user interface through which to receive student identification information from a student using the student workstation; and
the workstation is adapted to, upon receiving student identification information reconfigure itself for the aircrew classification associated with the received student identification information.

10. The system of claim 1 further comprising:
a mission recorder that records at least one of operator inputs, aircraft and synthetic entity movements, tactical plot info, synthetic information, and data received from aircraft systems.

11. The system of claim 2 further comprising at least one instructor workstation, wherein the simulation engine of each workstation is adapted to manage communication with the other workstations and is adapted to send and receive information to the aircraft interface.

12. The system of claim 2 wherein one of the models is a radar model provided as a separate executable application on a separate one of the plurality of processors of each student workstation; one of the models is an EO/IR model provided as a separate executable application on another separate one of the plurality of processors of each student workstation, one of the models is an acoustics model provided as a separate executable application on yet another separate processor of the plurality of processors of each student workstation.

13. The system of claim 1 wherein radar information is provided to the student workstation using at least one of:
an onboard radar system that provides live radar information to the system through the aircraft interface;
an onboard radar system that provides live radar information in combination with superimposed synthetic targets and returns; and
an entirely synthetic radar system.

14. The system of claim 1 wherein a plurality of radar modes are simulated, and wherein a subset of the plurality of radar modes to be trained is selectable on a per-student basis.

15. The system of claim 1 adapted to selectably implement the following scenarios:
an individual workstation running a separate independent simulation with the possible exception of information coming from the aircraft interface in the event that those interfaces are active;
workstations grouped together into one or more groups of workstations each constituting a “virtual crew”; with different crewmembers being assigned a respective aircrew personnel classification within a given virtual crew, such that activity by a model on one of the group of workstations will effect the corresponding models on the other workstations of the group.

16. The system of claim 15 wherein different mission scenarios and targets can be assigned to different workstations that may be operating independently or joined as part of the same virtual crew.

17. The system of claim 2 wherein:
for each workstation, each model generates a SIB (state information blocks) that is an update of information from that model that is shared with other models in that work station and with models on other workstations.

18. The system of claim 1 further comprising a ground-based system.

19. The system of claim 18 wherein a common software application is used in the air-based system and in the ground-based training system.

20. The system of claim 18 wherein the air-based system is further adapted to produce a simulation output that can be input to the ground-based system so that the simulations that were performed in an air environment can be examined in the ground-based system for debriefing purposes.

21. The system of claim 20 wherein after downloading the simulation output to the ground-based system, the ground-based system provides mission replay controls comprising fast forward, rewind and jump to bookmarks, and provides replay options comprising at least one of tactical plot information, operator selections, audio, synthetic entity and weather movement.

22. The system of claim 2 wherein each instructor workstation comprises an IOS (instructor operating system) that is a separate application that allows an instructor to communicate with students through the simulation engines, the IOS comprising interfaces and functionality for at least one of:
building virtual crew;
setting up scenarios and exercises;
modifying an exercise in real time;
adding new targets, adding weather or adding weapons fire;
selectively degrading or failing equipment;
controlling live vs. synthetic blend for at least one sensor/system; and
inserting “bookmarks” for event finding in debrief.

23. One or more computer readable media having computer executable instructions for implementing an aircrew training simulator when executed on a computer, the computer executable instructions comprising:
a simulation engine;
a plurality of models running under control of the simulation engine;
a user interface;
the aircrew training simulator being reconfigurable to A) simulate specific aircraft systems and sensors selected from a set of available systems and sensor and B) simulate training needs of a specific aircrew personnel classification selected from a set of available aircrew personnel classifications.

24. The computer readable media of claim 23 wherein the computer executable instructions further comprise: an information sharing mechanism for sharing information with other workstations.

25. The computer readable media of claim 24 wherein the instructions further comprise:
instructions for implementing a plurality of state information blocks as a mechanism for sharing information with other workstations;
instructions for implementing at least one SIB interface, a SIB interface collecting information from an external device and composing it into a SIB for use by the simulator.
